(19) United States
(12) Patent Application Publication
(10) Pub. No.: US 2024/0265140 A1
(43) Pub. Date: Aug. 8, 2024

(54) METHOD AND SYSTEM FOR OBTAINING REPRESENTATIVE SAMPLE OF AUTOMOTIVE DATA RECORDS FOR DATA SCORING

(71) Applicant: OTONOMO TECHNOLOGIES LTD., Herzeliya Pituach (IL)

(72) Inventor: Yosef Haim ITZKOVICH, Raanana (IL)

(73) Assignee: OTONOMO TECHNOLOGIES LTD., Herzeliya Pituach (IL)

(21) Appl. No.: 18/165,530

(22) Filed: Feb. 7, 2023

(51) Int. Cl. G06F 21/62

(52) U.S. Cl. CPC G06F 21/6254

(57) ABSTRACT

A method and system for obtaining representative sample of automotive data records for data scoring is provided herein. The method may include the following steps: applying a sampling operator to unique IDs of automotive data records space associated with connected vehicles represented by said unique IDs and respective automotive data sources, wherein the sampling operator is selected such that it preserve the proportions in the sample compared with the space; deriving a sample of automotive data records from said automotive data records by selecting a subset of the unique IDs with the sampling operator applied thereto, based on a sampling factor; verifying that the sample of automotive data records is a valid sample of the automotive data records space; and scoring the data records and or the data sources of the sample of automotive data records based on data scoring schemes.

### FIELD OF THE INVENTION

The present invention relates generally to the field of processing data features, and more particularly to processing automotive data records obtained from connected vehicles.

### BACKGROUND OF THE INVENTION

Prior to the background of the invention being set forth, it may be helpful to provide definitions of certain terms that will be used hereinafter.

The term “connected vehicle” as used herein is defined as a car or any other motor vehicle such as a drone or an aerial vehicle that is equipped with any form of wireless network connectivity enabling it to provide and collect data from the wireless network. The data originated from and related to connected vehicles and their parts is referred herein collectively as “automotive data”.

The term “data marketplace” or “data market” as used herein is defined as an online platform that enables a plurality of users (subscribers) to access and consume data. Data marketplaces typically offer various types of data for different markets and from different sources. Common types of data consumers include business intelligence, financial institutions, demographics, research, and market data. Data types can be mixed and structured in a variety of ways. Data providers may offer data in specific formats for individual clients.

Data consumed in these marketplaces may be used by businesses of all kinds, fleets, business and safety applications and many types of analysts. In order to properly consume the automotive data, data consumer need to have an idea regarding the quality and reliability of the data records and possibly of the data sources (providers). In order to achieve this end, the marketplace server can implement a scoring methodology associating data records and data sources with respective score.

One of the challenges in implementing such a scoring methodology on automotive data marketplace is the huge amount of automotive data that needs to be scored which makes the process almost prohibitively expensive and time consuming. It would be therefore advantageous to provide a solution for reducing the complexity of the automotive data scoring process, without undermining quality of the scoring.

### SUMMARY OF THE INVENTION

A trivial solution to the aforementioned challenge would be to sample a specific percentage of the automotive data records merely randomly. However, this trivial sampling would inevitably lead to an uneven distribution of unique IDs (representing connected vehicles) per data source. Even worse, this type of sampling will not be able to provide a good context for the data records for the entirety of the data associated with a specific ID (representing a vehicle) which is crucial for automotive data scoring. This is because many metrics associated with the quality of automotive data record, such as frequency, will be lost by such a sampling as shown in Table (1) below.

TABLE 1

| | |
|---|---|
| Vin1 | My ID1 |
| Vin2 | My ID2 |
| Vin3 | My ID3 |
| Vin4 | My ID4 |
| Vin5 | My ID5 |

Therefore, it has been suggested by the inventor of the present invention, to provide a sampling technique samples a specific percentage of the automotive data records while preserving the original data distribution of the original automotive data records space.

According to some embodiments of the present invention, the method may include the following steps: applying a sampling operator to unique IDs of automotive data records space associated with connected vehicles represented by said unique IDs and respective automotive data sources, wherein the sampling operator is selected such that it preserve the proportions in the sample compared with the space; deriving a sample of automotive data records from said automotive data records by selecting a subset of the unique IDs with the sampling operator applied thereto, based on a sampling factor; verifying that the sample of automotive data records is a valid sample of the automotive data records space; and scoring the data records and or the data sources of the sample of automotive data records based on data scoring schemes.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a block diagram illustrating non-limiting exemplary architecture of a marketplace server for managing data relating to connected cars in accordance with embodiments of the present invention; and

FIG. 2 is a high-level flowchart illustrating non-limiting exemplary method in accordance with embodiments of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following description, various aspects of the present invention will be described. For purposes of explanation, specific configurations and details are set forth in order to provide a thorough understanding of the present invention. However, it will also be apparent to one skilled in the art that the present invention may be practiced without the specific details presented herein. Furthermore, well known features may be omitted or simplified in order not to obscure the present invention.

Unless specifically stated otherwise, as apparent from the following discussions, it is appreciated that throughout the specification discussions utilizing terms such as “processing,” “computing”, “calculating”, “determining”, or the like, refer to the action and/or processes of a computer or computing system, or similar electronic computing device, that manipulates and/or transforms data represented as physical, such as electronic, quantities within the computing system's registers and/or memories into other data similarly represented as physical quantities within the computing system's memories, registers or other such information storage, transmission or display devices.

According to some embodiments of the present invention, the following stages are suggested as detailed hereinafter.

### The Sampling Stage

According to some embodiments of the present invention, some kind of sampling operator that preserves the proportions in the sample compared with the space. For example, the sampling operator can be a random-based hashing of the unique ID of the automotive data records is applied. Given the fact that that hashing is random, the suffix or the prefix digits of the hashed unique ID can be used as basis for applying the sampling.

One way to implement the actual sampling is to decide upon a sampling factor, for example 100 (yielding a sample of 1% out of the data original data records space), and then obtain the ID modulo of the sampling factor and take only the ones with the chosen modulo.

For example, where the sampling factor is 3, in case the original automotive data records space (after hashing) has the following unique IDs: 1033, 2055, 5303, 1325, 103, the obtained sample will include 5303 and 103.

The following are non-limiting three possible sampling processes that may be used to implement the sampling. According to the first sampling process, once a modulo is selected (e.g., ‘0’) it is being used thereafter for the entire sampling process. According to another sampling process, the sampling factor is chosen randomly and used thereafter. According to a third sampling process, before each sampling iteration, (e.g., each day or each month) a modulo is randomly chosen and then used only on that iteration. The next sampling iteration is repeated with a different modulo. This sampling process ensures sampling different IDs every iteration.

### The Validation Stage

According to some embodiments of the present invention, once the sample of automotive data records has been obtained, a few basic tests are run to make sure the sample is a valid sample. For example, total number of IDs checked to ensure it is approximately the percentage of the sample with an acceptable mistake (5% e.g). Thus, it is ensured that the number of unique IDs in the sample is in the right proportion as it is in the automotive data records space.

Optionally, the sample validation stage is repeated one or more times to provide better assurance the data is really randomly distributed and to make sure that the sampling process is statistically representative and sufficient for all practical purposes.

### The Data Scoring Stage

According to some embodiments of the present invention, specified grading algorithms are run and applied to the sample of automotive data records, and the scores are applied to the respective groups, classes, and types of data records and data sources of the automotive data space.

Optionally, the grading scoring algorithms are run one or more times over one or more different samples that have been obtained by a slightly different sampling factor or a slightly different sampling process. This is carried out in order to determine accuracy of the sample and use the difference and variance between the one or more samples and quality measurement for the sampling.

According to some embodiments of the present invention, it may be possible to select a different sampling factor per data source (data provider), according to the size of the unique IDs. For example, it can be decided that what sampling percentage of P % is required, it is desirable to have at least MIN different IDs and at most MAX different IDs. In a case that case the numbers of the IDs is out of the range it may be possibly to adjust the percentage accordingly. This ad hoc selection of sampling factors may ensure that the resulting sample is neither too small nor too large and overall improves accuracy and performance even more.

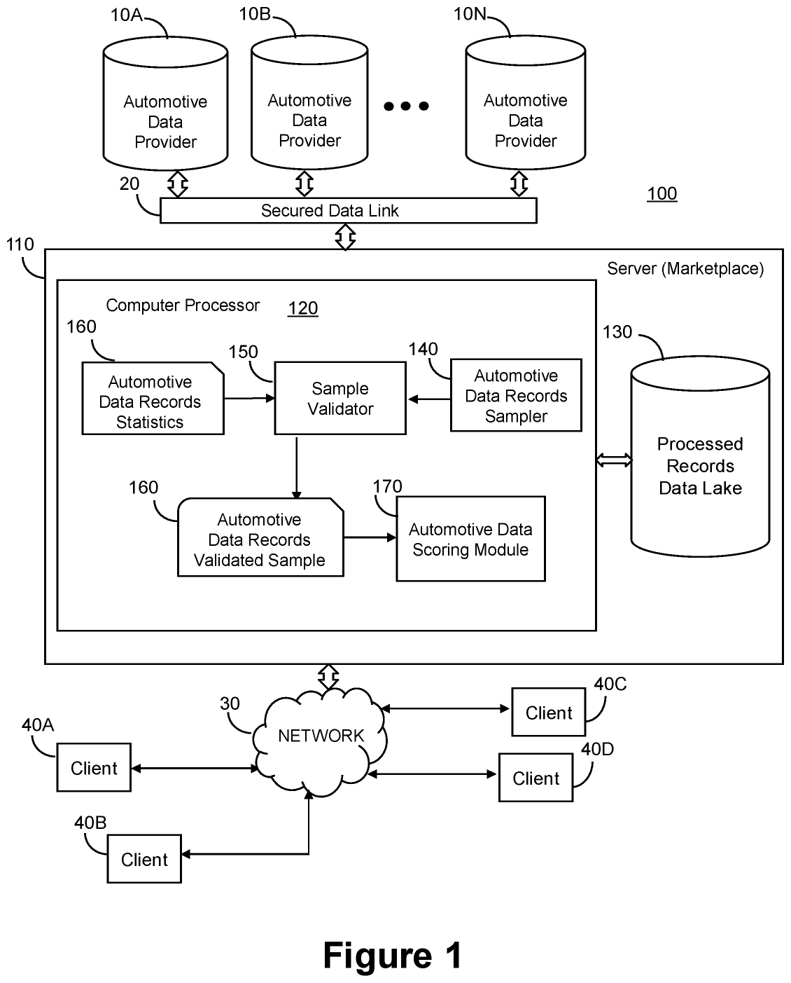

FIG. 1 is a block diagram illustrating non-limiting exemplary architecture of a system 100. System 100 may include a server 110 implementing the data marketplace and connected via network 30 to a plurality of clients 40A-40D. Automotive data, possibly obtained for various sensors may be stored in raw format on a plurality of automotive data sources 10A-10N and are accessed by server 110 via a secured data link 20.

Server 110 may include a processed records data lake 130 implemented by a computer readable code running on computer processor 120. In operation, computer processor is configured to collect, normalize, and anonymize respectively the data arriving from the plurality of vehicle related data sources 10A-10N, thus creating processed records data lake 130 for automotive data. The processed automotive data records are being consumed and used by various data services modules implemented by a computer code running on computer processor 120 on server 110 responsive to various requests from plurality of clients 40A-40D in a manner that does not compromise the privacy of the data owners (e.g., drivers).

In accordance with some embodiments of the present invention, computer processor 120 may be configured to have computer code which, when executed, implements an automotive data records sampler 140, which is applied to processed records data lake 130.

Computer processor 120 may further configured to have computer code which, when executed, implements a sample validator 150 which receives automotive data records samples from automotive data records sampler 140 and based on automotive data records statistics 160 generates automotive data records validated samples.

According to some embodiments, automotive data records sampler 140 may be implemented as a hash function. It is understood however, that any sampling operator selected such that it preserves the proportions in the sample compared with the space may work equally well.

In some embodiments of the present invention, computer processor 120 may include a hashing module configured to apply a hash function to unique IDs of automotive data records space associated with connected vehicles represented by said unique IDs and respective automotive data sources. computer processor 120 may further include a sampling module configured to derive a sample of automotive data records from said automotive data records by selecting a subset of the unique IDs with the hash function applied thereto, based on a sampling factor. Computer processor 120 may further include a verifying module configured to verify that the sample of automotive data records is a valid sample of the automotive data records space. Computer processor 120 may further include a data scoring module configured to score the data records and or the data sources of the sample of automotive data records based on data scoring schemes.

According to some embodiments of the present invention, sampling module of computer processor 120 is further configured to repeat the deriving a sample of automotive data records on or more time wherein in each of the one or more time, a different sampling factor is selected.

According to some embodiments of the present invention, verifying module of computer processor 120 is further configured to ascertain that similar data records groups at the sample of automotive data records retain their representation compared with their representation within the automotive data records space.

According to some embodiments of the present invention, the verifying is carried out by comparing statistics of the subset automotive data records with statistics of the plurality of anonymized automotive data records.

According to some embodiments of the present invention, the sampling is carried out using a modulo associated with the hashed unique ID.

According to some embodiments of the present invention, the sampling factor is adjusted in each sampling based on the number of unique IDs in the automotive data records space.

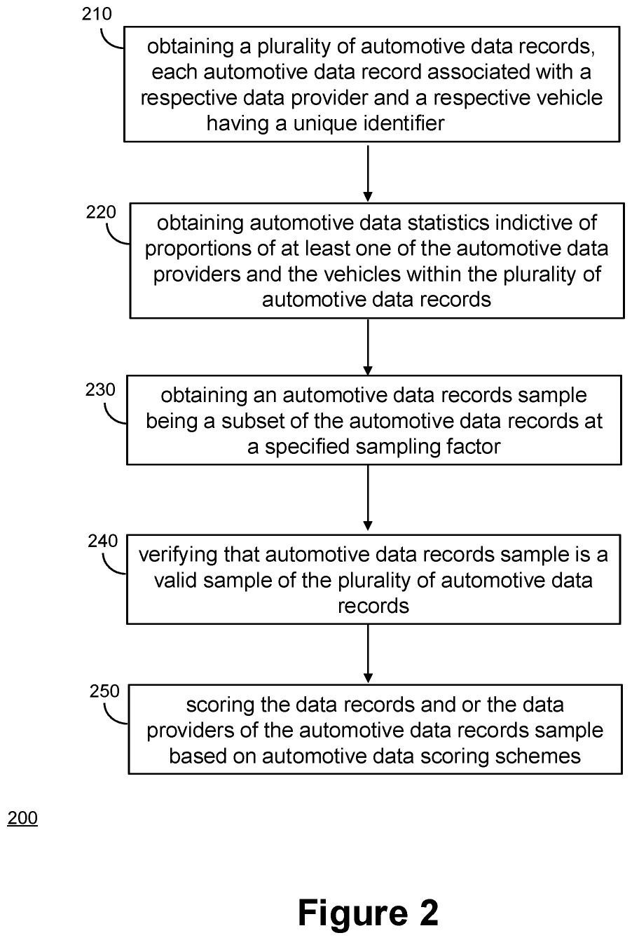

FIG. 2 is a high-level flowchart illustrating non-limiting exemplary method in accordance with embodiments of the present invention. According to some embodiments of the present invention a method of obtaining a representative sample of automotive data records for data scoring is provided herein. Method 200 may include the following steps: obtaining a plurality of automotive data records, each automotive data record associated with a respective data provider and a respective vehicle having a unique identifier 210; obtaining automotive data statistics indicative of proportions of at least one of the automotive data providers and the vehicles within the plurality of automotive data records 220; obtaining an automotive data records sample being a subset of the automotive data records at a specified sampling factor 230; verifying that automotive data records sample is a valid sample of the plurality of automotive data records 240; and scoring the data records and or the data providers of the automotive data records sample based on automotive data scoring schemes 250.

It should be noted that method 200 according to embodiments of the present invention may be stored as instructions in a computer readable medium to cause processors, such as central processing units (CPU) to perform the method. Additionally, the method described in the present disclosure can be stored as instructions in a non-transitory computer readable medium, such as storage devices which may include hard disk drives, solid state drives, flash memories, and the like. Additionally, non-transitory computer readable medium can be memory units.

In order to implement the method according to embodiments of the present invention, a computer processor may receive instructions and data from a read-only memory or a random-access memory or both. At least one of aforementioned steps is performed by at least one processor associated with a computer. The essential elements of a computer are a processor for executing instructions and one or more memories for storing instructions and data. Generally, a computer will also include, or be operatively coupled to communicate with, one or more mass storage devices for storing data files. Storage modules suitable for tangibly embodying computer program instructions and data include all forms of non-volatile memory, including by way of example semiconductor memory devices, such as EPROM, EEPROM, and flash memory devices and also magneto-optic storage devices.

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object-oriented programming language such as Java, Smalltalk, JavaScript Object Notation (JSON), C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and/or portion diagrams of methods, apparatus (systems) and computer program products according to embodiments of the invention. It will be understood that each portion of the flowchart illustrations and/or portion diagrams, and combinations of portions in the flowchart illustrations and/or portion diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or portion diagram portion or portions.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or portion diagram portion or portions.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or portion diagram portion or portions.

The aforementioned flowchart and diagrams illustrate the architecture, functionality, and operation of possible implementations of systems, methods and computer program products according to various embodiments of the present invention. In this regard, each portion in the flowchart or portion diagrams may represent a module, segment, or portion of code, which comprises one or more executable instructions for implementing the specified logical function(s). It should also be noted that, in some alternative implementations, the functions noted in the portion may occur out of the order noted in the figures. For example, two portions shown in succession may, in fact, be executed substantially concurrently, or the portions may sometimes be executed in the reverse order, depending upon the functionality involved. It will also be noted that each portion of the portion diagrams and/or flowchart illustration, and combinations of portions in the portion diagrams and/or flowchart illustration, can be implemented by special purpose hardware-based systems that perform the specified functions or acts, or combinations of special purpose hardware and computer instructions.

In the above description, an embodiment is an example or implementation of the inventions. The various appearances of “one embodiment,” “an embodiment” or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “some embodiments”, “an embodiment”, “one embodiment” or “other embodiments” means that a particular feature, structure, or characteristic described in connection with the embodiments is included in at least some embodiments, but not necessarily all embodiments, of the inventions.

It is to be understood that the phraseology and terminology employed herein is not to be construed as limiting and are for descriptive purpose only.

The principles and uses of the teachings of the present invention may be better understood with reference to the accompanying description, figures and examples.

It is to be understood that the details set forth herein do not construe a limitation to an application of the invention.

Furthermore, it is to be understood that the invention can be carried out or practiced in various ways and that the invention can be implemented in embodiments other than the ones outlined in the description above.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional elements.

It is to be understood that where the claims or specification refer to “a” or “an” element, such reference is not be construed that there is only one of that elements.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs.

The descriptions, examples, methods and materials presented in the claims and the specification are not to be construed as limiting but rather as illustrative only.

Meanings of technical and scientific terms used herein are to be commonly understood as by one of ordinary skill in the art to which the invention belongs, unless otherwise defined.

The present invention may be implemented in the testing or practice with methods and materials equivalent or similar to those described herein.

Any publications, including patents, patent applications and articles, referenced or mentioned in this specification are herein incorporated in their entirety into the specification, to the same extent as if each individual publication was specifically and individually indicated to be incorporated herein. In addition, citation or identification of any reference in the description of some embodiments of the invention shall not be construed as an admission that such reference is available as prior art to the present invention.

While the invention has been described with respect to a limited number of embodiments, these should not be construed as limitations on the scope of the invention, but rather as exemplifications of some of the preferred embodiments. Other possible variations, modifications, and applications are also within the scope of the invention. Accordingly, the scope of the invention should not be limited by what has thus far been described, but by the appended claims and their legal equivalents.

1. A method of obtaining a representative sample of automotive data records for data scoring, the method comprising:
applying a sampling operator to unique IDs of automotive data records space associated with connected vehicles represented by said unique IDs and respective automotive data sources, wherein the sampling operator is selected such that it preserves the proportions in the sample compared with the space;
deriving a sample of automotive data records from said automotive data records by selecting a subset of the unique IDs with the sampling operator applied thereto, based on a sampling factor;
verifying that the sample of automotive data records is a valid sample of the automotive data records space; and
scoring the data records and or the data sources of the sample of automotive data records based on data scoring schemes.

2. The method according to claim 1, further comprising: repeating the deriving a sample of automotive data records on ore more time wherein in each of the one or more time, a different sampling factor is selected.

3. The method according to claim 1, wherein the verifying is carried out by ascertaining that similar data records groups at the sample of automotive data records retain their representation compared with their representation within the automotive data records space.

4. The method according to claim 1, wherein the verifying is carried out by comparing statistics of the subset automotive data records with statistics of the plurality of anonymized automotive data records.

5. The method according to claim 1, wherein the sampling is carried out using a modulo associated with the sampled unique ID.

6. The method according to claim 1, wherein the sampling factor is adjusted in each sampling based on the number of unique IDs in the automotive data records space.

7. A server for obtaining a representative sample of automotive data records for data scoring, the server comprising:
a sampling module configured to:
apply a sampling operator to unique IDs of automotive data records space associated with connected vehicles represented by said unique IDs and respective automotive data sources, wherein the sampling operator is selected such that it preserve the proportions in the sample compared with the space;
derive a sample of automotive data records from said automotive data records by selecting a subset of the unique IDs with the sampling operator applied thereto, based on a sampling factor;
a verifying module configured to verify that the sample of automotive data records is a valid sample of the automotive data records space; and
a data scoring module configured to score the data records and or the data sources of the sample of automotive data records based on data scoring schemes.

8. The server according to claim 7, further comprising: repeating the deriving a sample of automotive data records on or more time wherein in each of the one or more time, a different sampling factor is selected.

9. The server according to claim 7, wherein the verifying is carried out by ascertaining that similar data records groups at the sample of automotive data records retain their representation compared with their representation within the automotive data records space.

10. The server according to claim 7, wherein the verifying is carried out by comparing statistics of the subset automotive data records with statistics of the plurality of anonymized automotive data records.

11. The server according to claim 7, wherein the sampling is carried out using a modulo associated with the sampled unique ID.

12. The server according to claim 7, wherein the sampling factor is adjusted in each sampling based on the number of unique IDs in the automotive data records space.
